(19) United States
(12) Patent Application Publication
(10) Pub. No.: US 2015/0177194 A1
(43) Pub. Date: Jun. 25, 2015

(54) Dual Robot Detection Apparatus For Non-Damage Detection

(71) Applicant: Beijing Institute of Technology, Beijing (CN)

(72) Inventors: Chunguang Xu, Beijing (CN); Xinyu Zhao, Beijing (CN); Lan Zhang, Beijing (CN); Hongbo Wang, Beijing (CN); Dingguo Xiao, Beijing (CN); Juan Hao, Beijing (CN); Zongxin Lu, Beijing (CN)

(21) Appl. No.: 14/411,319

(22) PCT Filed: Jul. 4, 2013
(86) PCT No.: PCT/CN2013/078806

§ 371 Date: Mar. 5, 2015

(30) Foreign Application Priority Data
Jul. 4, 2012 (CN) 201210230995.1

(51) Int. Cl. G01N 29/04; B25J 9/16

(52) U.S. Cl. CPC G01N 29/043; B25J 9/1661; B25J 9/1664; G01N 2291/0231; G01N 2291/044; G01N 2291/105

(57) ABSTRACT

Disclosed is a twin-robot testing apparatus for non-destructive testing. The apparatus comprises two robots (1) for detecting a workpiece (3) from front and back sides thereof; a water circulating unit, comprising a pressure pump, two water ejection coupling probes (2) and water pipes, for providing a coupled water column; an ultrasonic transmitting/receiving device, comprising two ultrasonic transducers, a pulse transmitting/receiving card, and a high-speed data acquisition card, wherein the two ultrasonic transducers are respectively attached at the end-effector of the two robots (1), for transmitting ultrasound and receiving ultrasound respectively, the ultrasonic pulse transmitting/receiving card and the high-speed data acquisition card are mounted on the robot controller mechanism for transmitting and receiving, and acquiring pulse signals, the two robots perform a synchronous transmission testing, with ultrasound transmitted by one robot being received by the other robot, and the ultrasonic transducers are adjusted in position and gesture with the change in the surface shape of the workpiece (3) such that the incidence direction of ultrasonic beam is always in coincidence with the normal direction of the curved surface. The apparatus is used for automatic non-destructive testing of a curved-surface workpiece made of a composite material, and can improve the accuracy, sensitivity and efficiency of the testing.

### FIELD OF THE INVENTION

The presented invention relates to a robot testing apparatus mainly used for flaw testing of a composite material with a large-scale curved surface, which belongs to the field of non-destructive testing.

### BACKGROUND OF THE INVENTION

Composite materials, with advantages such as light weight, high strength, high heat-insulating property etc., have been widely applied in the fields of aerospace, automobile, ocean, and chemical engineering. During the manufacturing and using process of composite materials, the existence or occurrence of flaws like cracks, voids and lamination defects is inevitable, directly affecting the quality of workpieces made of composite materials. With advantages such as great propagated energy, high penetration, low cost of the apparatus, portable structure, etc., the ultrasonic testing has been applied widely in flaw testing of composite materials. As a common method for flaw testing of composite materials, the ultrasonic transmission testing method has a significant strength in the aspects of penetrability and sensitivity of testing, and is suitable for the testing of curved-surface composite materials with more severe attenuation and larger thickness.

For testing of the shape of workpieces made of composite materials, it is much easier to realize ultrasonic automatic testing for workpieces having simple profiles (e.g. a plane, a rotary body etc.), which has been introduced in the relevant literature and can be achieved through a scanning apparatus with at most 5 DOF axis system. However, it is more difficult to perform automatic testing for curved-surface workpieces with complex profiles. Xiaojun Zhou et al. from Zhejiang

University developed an automatic multiple-axis testing system for workpieces with curved surfaces. However, the testing system is based on the original 5 DOF axis scanning system, and is not suitable for testing of large-scale workpieces with complex curved surfaces due to the limitation of the size of the scanning frame. The application of servo motor for driving multiple axes has certain limitation in the speed and accuracy of testing.

### SUMMARY OF THE INVENTION

In view of the above problems, the present invention aims at providing a robot testing apparatus for performing automatic non-destructive flaw testing of curved-surface workpieces made of composite materials, solving the problems that it is difficult for the original 5 DOF axis ultrasonic scanning system to detect workpieces with large-scale curved surfaces, and meanwhile improving the accuracy, sensitivity and efficiency of flaw testing.

The invention provides a robot testing apparatus, comprising two robots controlled by a robot controller mechanism and configured to detect a workpiece from front and back sides thereof; a water circulating unit, comprising a pressure pump, a water ejection coupling probe and a water pipe which are attached at the end-effector of the robots, wherein the pressure pump delivers the water for coupling to the water ejection coupling probe through the water pipe in order to provide a coupled water column; an ultrasonic transmitting/receiving device, comprising two ultrasonic transducers, a pulse transmitting/receiving card, and a high-speed data acquisition card, wherein the two ultrasonic transducers are respectively attached at the end-effector of the two robots, for transmitting ultrasound and receiving ultrasound respectively, the ultrasonic pulse transmitting/receiving card and the high-speed data acquisition card are mounted on the robot control mechanism and are used for transmitting and receiving, and acquiring pulse signals, the two robots perform a synchronous transmission testing, with ultrasound transmitted by one robot being received by the other robot, and the ultrasonic transducers are adjusted in position and orientation with the change in the surface shape of the workpiece such that the incidence direction of ultrasonic beam is always in coincidence with the normal direction of a curved surface.

The robot testing apparatus in the present invention performs testing by the way of ultrasonic transmission method with employment of two robots. The speed and accuracy of testing has been greatly improved compared with the ultrasonic testing system with scanning frame in the prior art, and meanwhile without any limitation of the size of the scanning frame, the testing for workpieces with large-scale curved surfaces is allowed by selecting robots with different lengths of arms.

### BRIEF DESCRIPTION OF THE DRAWINGS

FIG. 1 is a block diagram of structure of a twin-robot ultrasonic transmission testing apparatus,

FIG. 2 is a schematic diagram of twin-robot testing for a composite material with a curved surface.

### DESCRIPTION OF THE EMBODIMENTS

Now the embodiments of the invention will be described in detail as follows. Referring to FIG. 2, a schematic diagram of twin-robot testing for a composite material with a curved surface, “1” in the figure is a advanced robot; “2” is a water ejection coupling probe; and “3” is a detected workpiece made of a composite material.

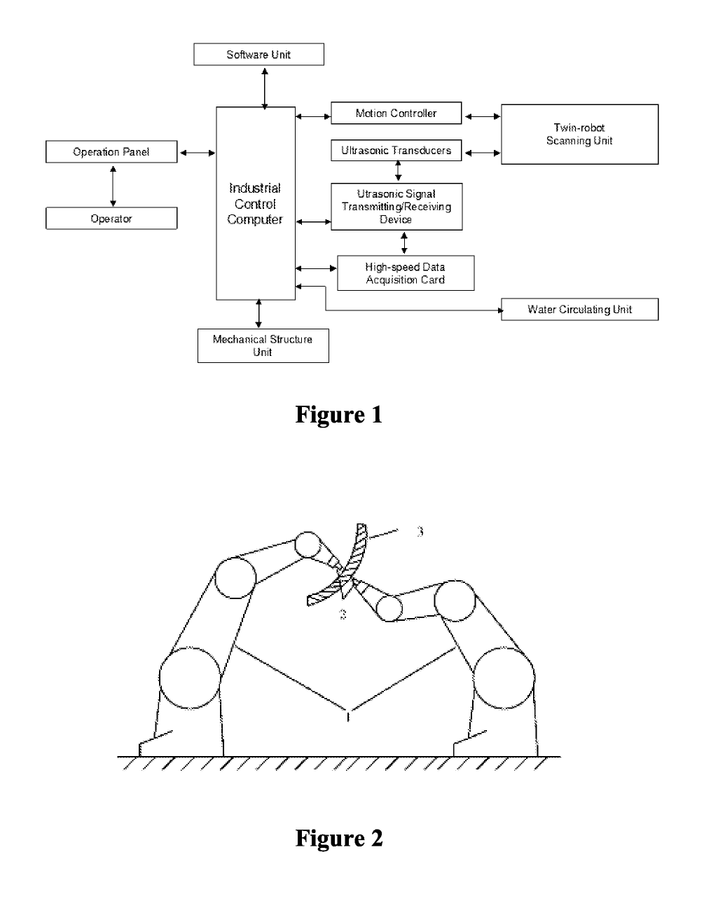

In the present embodiment, as shown in FIG. 1, the robot testing apparatus can be divided into a mechanical structure unit, a hardware unit and a software unit. As the base of the whole testing system, the mechanical structure unit comprises a advanced robot 1, a pedestal, a motion guide rail for the workpiece, a water circulating unit, a workpiece bracket etc.; the hardware unit, namely all the electronic hardware devices used in the testing system, comprises an industrial control computer, an ultrasonic transmitting/receiving mechanism, an electric control cabinet etc.; the software unit comprises system management, ultrasound transmission/receipt and signal acquisition, profile tracking, motion controller, signal processing, image display and parameter setting module and so on. An ultrasonic transmitting/receiving mechanism includes ultrasonic transducers, a pulse transmitting/receiving card and a high-speed data acquisition card, wherein the ultrasonic pulse transmitting/receiving card and high-speed data acquisition card are mounted on the industrial control computer, and perform the transmission/receipt and acquisition of pulse signals under the control of the industrial control computer.

The robot 1 has many advantages such as fast movement, high accuracy, good flexibility etc. The major task of performing a real-time accurate control to the robot 1 is completed by the robot controller mechanism. A water ejection coupling probe 2 is attached at the end-effector of the robot 1. A system structure mode of combined control by upper computer and lower computer is adopted in the robot control mechanism in order to realize the real-time control of the robot and higher accuracy of control. The upper computer is a high performance industrial control computer, mainly responsible for the tasks like path planning, task allocation, system inspection etc.; the lower computer employs a motion controller for the advanced robot, which uses the latest PC control and optical fiber communication, digital and fieldbus control technology, and an absolute coding system performed by DSI (dual sensor interface board in arm) for the robot system, mainly responsible for servo control and signal acquisition of the position sensor.

The pedestal is configured to connect and support each of major components (including two robots, a workpiece bracket, a motion guide rail for the workpiece etc.), with a rectangular groove shape, i.e. surrounded by steel plates exceeding the bottom for 5 cm to 10 cm, for storing the water spilled by the water ejection probe during testing.

Both ends of the motion guide rail for the workpiece should be fixed with the pedestal, meanwhile embedded inside the pedestal, and are water resistant. A workpiece bracket is mounted on the motion guide rail for the workpiece to drive the detected workpiece to move.

During the water ejection testing process, the pressure pump of the water circulating unit delivers the water for coupling to the front-end water ejection probe via the plastic water pipe fixed on the robot for providing a coupled water column with stable pressure and flow rate, and flow status close to laminar flow, and without air bubbles, wherein stabilizing the pressure and flow as well as degassing can be completely achieved at the front-end system, and hydraulics design of the nozzle need to be performed to control the flow status of the coupled water column.

When performing the ultrasonic testing for a curved-surface workpiece 3 made of a composite material, due to the existence of surface curvature of the workpiece, the ultrasonic beam would have rather complicated transmission such as scattering, reflecting and refracting etc. In order to ensure an incidence of a stronger ultrasonic signal into the workpiece 3, it is required for the ultrasonic transducers to automatically follow the change in the surface shape of the workpiece. When there is a change in the profile curvature of the detected workpiece, the software unit should control the advanced robot to drive the transducers to adjust their position and orientation, i.e. to ensure that the incidence direction of ultrasonic waves is always in coincidence with the normal direction of a curved surface. When there is a certain angle shift between the actual position of the ultrasonic transducers and normal vector of the external surface, the scattering of sound waves by the up and down surfaces of the workpiece and the flaw in the workpiece increases, resulting in reduced, even none actual amplitudes of sound waves being received by the receiving probe. Therefore, it is necessary to ensure that the direction of the probe is accurately controlled by the mechanical axis of the testing apparatus so that the transmitting and receiving probe is always pointed to the normal direction of the surface of the detected component.

Surface coordinate data of the curved surface to be detected need to be acquired first in order to realize the automatic accurate testing of the workpiece with a curved surface. For the twin-robot testing system, each of the robots has its own Cartesian and tool coordinate frame. In order to realize the synchronous transmission testing by two robots, a public coordinate frame need to be established first and tool coordinate position of two robots should be located within the public coordinate frame.

There are two modes for generating and planning of trajectory path for the workpiece with a curved surface, including automatic testing mode and teaching testing mode. For the detected workpiece with a curved surface of which a CAD model is known, the CAD 3D data can be directly input into the software unit to generate testing scanning path automatically, wherein the basic principle is that scanning points may be set to be intensive for a large curvature change, while scanning points may be set to be loose for a small curvature change. For the detected workpiece with an unknown CAD model, the testing scanning path should be generated by employing the teaching testing mode, through the following basic process: firstly after fixing the workpiece with a curved surface, key point sampling is conducted manually, i.e. the line or several measurement points which can best reflect the surface feature are found in the curved surface. The measurement and calculation for the acoustic distance is implemented by using ultrasonic reflection echo method and point coordinates at the moment are recorded. Moving to the next measurement point and keeping the acoustic distance constant so that a certain number of point coordinates of curved-surface trajectory can be obtained, and the initial curved surface is built with measured coordinate points by a method of curve fitting. With curved surface model, path planning is performed according to the requirements of testing spacing and testing efficiency etc., and the curved surface is dispersed into a series of measurement point coordinates. The ultrasonic signals at each testing points are acquired, and a real-time drawing of testing image is completed.

To realize accurate synchronous testing by twin-robot, two methods can be used to complete the generating and planning of testing path. One is with respect to the workpieces with constant thickness in each portion, a synchronous testing method by the master and slave robots is adopted. First, the coordinates of measurement points on the curved surface can be obtained from the single movement of the master robot, and then the coordinates of trajectory points for the slave robot can be acquired through the parameters synchronization setup program of the motion controller. The other is each of the master and slave robots should obtain its own coordinates of the measurement points through the above method with respect to the workpieces with changed thickness.

The workpiece with a curved surface can move parallel to the ground through motion guide rail, and meanwhile the workpiece bracket has the lifting function, so that it is possible to move the detected workpiece to different testing positions, and then to complete flaw testing for different portions of the workpiece through the twin-robot testing system. In this way the problem of detecting a large-scale workpiece with a curved surface can be solved.

What is claimed is:

1. a robot testing apparatus, comprising:
two robots controlled by a robot controller mechanism and configured to detect a workpiece from front and back sides thereof;
a water circulating unit, comprising a pressure pump, two water ejection coupling probes and water pipes which are attached at the end-effector of the robots, wherein the pressure pump delivers the water for coupling to the water ejection coupling probes through the water pipe in order to provide a coupled water column
an ultrasonic transmitting/receiving device, comprising two ultrasonic transducers, a pulse transmitting/receiving card, and a high-speed data acquisition card, wherein the two ultrasonic transducers are respectively attached at the end-effector of the two robots, for transmitting ultrasound and receiving ultrasound respectively, the ultrasonic pulse transmitting/receiving card and the high-speed data acquisition card are mounted on the robot control mechanism for transmitting and receiving, and acquiring pulse signals, the two robots perform a synchronous transmission testing, with ultrasound transmitted by one robot being received by the other robot, and the ultrasonic transducers are adjusted in position and orientation with the change in the surface shape of the workpiece such that the incidence direction of ultrasonic beam is always in coincidence with the normal direction of a curved surface.

2. The robot testing apparatus according to claim 1, wherein a robot control mechanism employs a system structure mode of an upper and lower computer combined control, wherein the upper computer is an industrial control computer, used for planning the path of the robots, task allocation and system inspection, and the lower computer is a robot motion controller, which can perform servo control and signal acquisition for the position sensor.

3. The robot testing apparatus according to claim 1, wherein each of the robots has 6 degree of freedom, the whole testing system can have at most 14 degree of freedom.

4. The robot testing apparatus according to claim 1, further comprising a workpiece bracket for supporting the workpiece, and a motion guide rail for the workpiece, the workpiece with a curved surface can move parallel to the ground through the motion guide rail for the workpiece, and meanwhile the workpiece bracket has a lifting function to move the detected workpiece to different testing positions.
